(19) United States
(12) Patent Application Publication
(10) Pub. No.: US 2008/0064842 A1
(43) Pub. Date: Mar. 13, 2008

(54) In-Situ Chain Extended Rtv-Curing Polyether

(76) Inventors: Anthony Francis Jacobine, Meriden, CT (US); Steven Thomas Nakos, Andover, CT (US)

Correspondence Address: LOCTITE CORPORATION, 1001 TROUT BROOK CROSSING, ROCKY HILL, CT, 06067, US

(21) Appl. No.: 11/575,895

(22) PCT Filed: Sep. 21, 2005
(86) PCT No.: PCT/US05/34005

§ 371 Date: Mar. 23, 2007

Related U.S. Application Data
(60) Provisional application No. 60/612,574, filed on Sep. 23, 2004.

(51) Int. Cl. C08G 77/04; C08G 18/48; C08G 18/71

(52) U.S. Cl. 528/28; 528/69

(57) ABSTRACT

The present invention provides moisture-curable polymeric compositions, overcoming disadvantages normally associated with moisture-curable polymeric compositions, a process for their preparation, and methods of use thereof. The process included in the present invention ensures full end-capping. Furthermore, the present invention makes use of diisocyanates to chain-extend polyether polyols to a desired length. This allows the process of the present invention to accommodate a wide range of polyether polyols in the synthesis of the compounds of the invention. Additionally, the process of the present invention reduces the level of unreacted isocyanate to an acceptable level of approximately 0.1 wt %.

### FIELD OF THE INVENTION

The present invention pertains to a moisture curable polymeric composition capped with alkoxysilanes, the preparation of such a composition, and uses thereof. More particularly, the invention pertains to a fast-curing resin with an essentially polyether backbone, which may contain an extender component, capped with trimethoxysilanes.

### BACKGROUND OF THE INVENTION

It is well known that poly(alkylene)ether glycols may be reacted with alkylsiloxyisocyanates to form alkoxysilane end-capped polyethers. However, there are significant disadvantages associated with this process. Water content is difficult to monitor and control accurately in real time in a manufacturing environment, rendering it difficult to ascertain the precise amount of alkylsiloxyisocyanate necessary for the reaction. This can result in inconsistent end-capping, on account of which a smaller percentage of terminal alkoxy groups result, and thus fewer sites are available for cross-linking. Furthermore, unacceptably high levels of the free isocyanate, a potential health hazard, may be left over.

Additionally, the use commercially available poly(alkylene)ether glycols of particular molecular weights depends on the availability of the poly(alkylene)ether glycol. This can cause significant inconveniences if production of the glycol is discontinued or if the poly(alkylene)ether glycol is manufactured in only limited quantities, as the desired end-product may require that such a poly(alkylene)ether glycol be in a particular molecular weight range.

### SUMMARY OF THE INVENTION

The present invention provides moisture-curable polymeric compositions, overcoming disadvantages normally associated with moisture-curable polymeric compositions, a process for their preparation, and methods of use thereof. The process included in the present invention ensures full end-capping. Furthermore, the present invention makes use of diisocyanates to chain-extend polyether polyols to a desired length. This allows the process of the present invention to accommodate a wide range of polyether polyols in the synthesis of the compounds of the invention. Additionally, the process of the present invention reduces the level of unreacted isocyanate to an acceptable level of approximately 0.1 wt %.

In one aspect, the present invention relates to a moisture curable composition having the structure of formula (I):

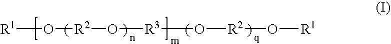

wherein
R¹ is an N-(alkoxysilylalkylene)carbamoyl group;
R² is a hydrocarbon diradical;
R³ is a diradical bis-carbamoyl;
n is 150 to 500;
m is 0.2 to 1.0; and
q is n.

In another aspect, the present invention relates to a method for preparing a polymer including the steps of:
a) reacting a polyether polyol with an alkylene or arylene diisocyanate to produce a first reaction mixture containing a first product;
b) endcapping the first reaction product by reacting it with a alkoxysilylalkylene diisocyanate to produce a second reaction mixture containing a second reaction product; and
c) adding to the second reaction mixture an amino alkylenealkoxysilane at a time when the alkoxysilylalkylene diisocyanate consumption has been determined to have plateaued, so as to reduce the amount of any unreacted isocyanate groups.

In yet another aspect, the present invention relates to a composition resulting from the reaction of (i) a polyurethane diol produced by the reaction of a) a polyether polyol and b) an alkylene or arylene diisocyanate; and (ii) an alkoxysilylalkylene isocyanate.

In still another aspect, the present invention relates to a compound having the structure: 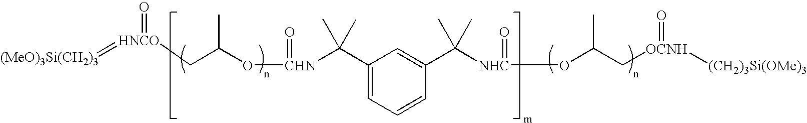
wherein the ratio of m to q is 0.74 to 207.00.

### DETAILED DESCRIPTION

The moisture curable compositions of the present invention include prepolymers illustrated by formula (I):

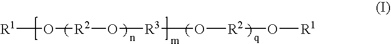

wherein
R¹ is an N-(alkoxysilylalkylene)carbamoyl group;
R² is a hydrocarbon diradical;
R³ is a diradical bis-carbamoyl;
n is 150 to 500;
m is 0.2 to 1.0; and
q is n.

The N-(alkoxysilylalkylene)carbamoyl group R¹ provides the composition with its ability to undergo room temperature vulcanization. Advantageously, the R¹ group is depicted by the structure:

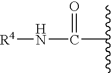

wherein
R⁴ has the formula R⁹₍₃₋ₓ₎Si(OR⁷)_{X}—R⁸—;
each R⁷, individually, is straight-chained or branched C₁-C₆ alkyl;
R⁸ is straight-chained or branched C₁-C₄ alkylene;
each R⁹, individually, is straight-chained or branched C₁-C₆ alkyl; and
X is 1 to 3.

In an advantageous embodiment, R⁴ is a trialkoxysilylalkylene having the formula Si(OR⁷)₃—R⁸—.

Particularly, the composition undergoes room temperature vulcanization by means of moisture-curing. In part, the moisture-cure rate is affected by the type of alkoxide substituent on the Silane. It is well known that, because of their reactivity, methoxy- and ethoxysilanes are among the most popular cross-linking agents, see e.g., Knoll, W., “Chemistry and Technology of Silicones,” Academic Press, New York (1968), p. 397. Accordingly, in an advantageous aspect, each R⁷, individually, is methyl or ethyl. In a most advantageous aspect, R⁷ is methyl.

Other factors can affect the rate at which a siloxane will moisture cure. A carbamate group located near a siloxane can increase the cure rate. Accordingly, in an advantageous aspect, alkylene R⁸ is methylene, ethylene, or propylene. In a most advantageous aspect, R⁸ is propylene.

One aspect of the present invention includes the composition of formula (I) and a moisture cure catalyst. The moisture-cure catalyst enhances the rate at which the hydrolyzable groups react with moisture to cure. The moisture cure catalyst may be any such conventional cure catalyst known to those skilled in the art. Illustrative examples include, but are not limited to various organometallic compounds and complexes such as: organic titanium derivatives such as tetraisopropylorthotitanate and tetrabutoxyorthotitanate; organic tin derivatives such as dibutlytindioctate; and organic copper derivatives such as copper octoate. Mixtures of such moisture cure catalysts may be used. The moisture cure catalyst should be used in an amount sufficient to effectuate moisture cure, which desirably is in the range of about 0.1% to about 5% by weight.

The polymeric alkylene oxide backbone contains repeating units of alkylene oxides. The polymeric backbone may contain a strand of identical repeating monomer units. In another aspect, it may be alternating copolymeric, and contain a strand of alternating units of two different monomer units. In an advantageous aspect, the polymeric backbone contains a strand of identical repeating monomer units. A commercially available example of an advantageous aspect of the polymeric backbone is the polyether polyol sold under the trade name Acclaim 12200™, produced by Bayer Polymers. In particular, Acclaim 12200 polyol is a 11,200 molecular-weight diol based on propylene oxide. Acclaim 12200 polyol is used in polyurethane and other applications, including cast elastomers, sealants, epoxy flexibilizers, defoamers, lubricants, crude oil de-emulsifiers, and plasticizers.

The hydrocarbon diradicals of R² of which the polyether polyol is composed are straight-chained or branched hydrocarbon diradicals having from two to ten carbon atoms. In an advantageous aspect, R² is a C₂-C₆ alkylene diradical. Representative hydrocarbon diradicals include, but are not limited to, those individual hydrocarbon diradicals obtained from ethylene oxide, propylene oxide, 1,2-epoxybutane, and 2,3-epoxybutane. Shown below, for example, is a monomeric unit advantageously used in the present invention, obtained from propylene oxide:

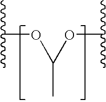

Preparation and properties of polyols using these hydrocarbons are discussed in the literature, e.g., Saunders, J. H., and Frisch, K. C., “Polyurethanes—Chemistry and Technology,” Interscience, New York, N.Y. (1963), the subject matter of which is herein incorporated by reference. In an advantageous aspect, the hydrocarbon diradical is that obtained from propylene oxide.

The polyether polyol may be reacted with a diisocyanate, resulting in a polyether polyol of a desired length. Substituent R³ is the diradical bis-carbamoyl resulting from the reaction of the diisocyanate with the polyether polyol, and it has the structure: 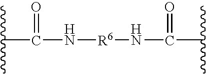
wherein R⁶ is a C₁-C₂₀ hydrocarbon diradical. Illustrative of the diisocyanates employed in the preparation of the chain-extended polyether polyol are, among others, phenyl diisocyanate, toluene diisocyanates (such as tolylene-2,4-diisocyanate, “TDI”), 4,4′-diphenyl diisocyanate, 4,4′-diphenylene methane diisocyanate (“MDI”), dianisidine diisocyanate, 1,5-naphthalene diisocyanate, 4,4′-diphenyl ether diisocyanate, p-phenylene diisocyanate, 4,4′-dicyclo-hexylmethane diisocyanate, isophorone diisocyanate, 1,4 hexamethylene diisocyanate, 1,4-phenylene diisocyanate, 1,4-phenylene diisocyanate, 1,4-cyclohexene diisocyanate, 1,3-bis-(isocyanatomethyl)cyclohexane, cyclohexylene diisocyanate, tetrachlorophenylene diisocyanate, 2,6-diethyl-p-phenylenediisocyantate and 3,5-diethyl-4,4′-diisocyanatodiphenyl-methane. In an advantageous aspect, the diisocyanate is meta-tetramethylkylylene diisocyanate. A commercially available example of meta-tetramethylxylylene diisocyanate is the compound sold under the trade name TMXDI™ by Cytec Industries, Inc., with the structure shown below:

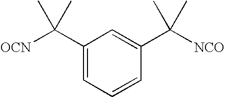

This isocyanate is considered aliphatic because the N═C═O is not directly conjugated to the aromatic ring. The steric hindrance by the dimethyl groups lowers the reactivity and reduces hydrogen bonding.

In an advantageous aspect, the polyether polyol may be extended by reaction with the diisocyanate to produce a polymer with a weight of about 12,000-24,000 atomic mass units. More advantageously, the polyether polyol may be extended to a molecular weight of about 18,000 atomic mass units.

Illustrative of an advantageous aspect of the invention is a composition with the structure:

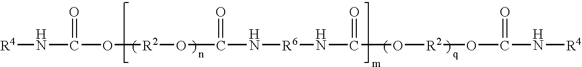

wherein
R² is a C₂-C₆ alkylene;
R⁴ is a moisture curable alkoxysilylalkylene radical;
R⁶ is a C₁-C₂₀ hydrocarbon diradical having 1 to 20 carbon atoms;
n is 150 to 500;
m is 0.2 to 1.0; and
q is n.

In another aspect, the invention relates to a method for preparing a polymer. The first step of the process entails reacting a polyether polyol with a diisocyanate to produce a first reaction mixture containing a first product. In an advantageous aspect, the first product may have a molecular weight of about 12,000 to about 24,000 atomic mass units. More advantageously, the first product may have a molecular of about 18,000 atomic mass units. In another advantageous aspect, the polyether polyol is propylene oxide polyol having an average molecular weight of about 10,000 to about 14,000 atomic mass units.

The second step of the process entails end-capping the first reaction product by reacting it with an alkoxysilylalkylene isocyanate to produce a second reaction mixture containing a second reaction product. In an advantageous aspect, the end-capping is performed at a time when the diisocyanate consumption has been determined to have plateaued. In another advantageous aspect, the alkoxysilylalkylene isocyanate has the formula R⁹₍₃₋ₓ₎Si(OR⁷)_{X}—R⁸—NCO, wherein X, R⁷, R⁸, and R⁹ are as defined above. In still another advantageous embodiment, the alkoxysilylalkylene isocyanate is a trialkoxysilylalkylene having the formula Si(OR⁷)₃—R⁸—NCO

The third step of the process entails adding to the second reaction mixture an amino alkylenealkoxysilane at a time when the alkoxysilylalkylene diisocyanate consumption has been determined to have plateaued, so as to reduce the amount of any unreacted isocyanates. In an advantageous aspect, the unreacted isocyanates are reduced to a level of about 0.1 wt % or less. In another advantageous aspect, the amino alkylenealkoxysilane is an amino alkylenetrialkoxysilane.

In yet another aspect, the present invention relates to the reaction product of (i) a polyurethane diol produced by the reaction of a) a polyether polyol and b) an alkylene or arylene diisocyanate; and (ii) an alkoxysilylalkylene isocyanate. In an advantageous embodiment, the alkoxysilylalkylene isocyanate is a trialkoxysilylalkylene isocyanate. In a most advantageous embodiment, the alkoxysilylalkylene isocyanate is a trimethoxysilylpropylene isocyanate.

In still another aspect, the present invention relates to a composition having the structure: 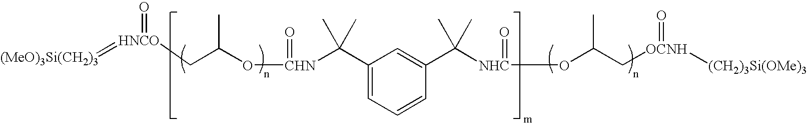
in which the ration of m to q is 0.74 to 207.

As used herein, the term “alkoxysilylalkylene” is intended, in whatever context it is used, to include any suitable alkoxysilylalkylene known to those skilled in the art, and is furthermore intended to include alkylalkoxysilylalkylene groups within its scope. For example, in one aspect of the present invention, the alkoxysilylalkylene group may be a methyldimethoxysilylpropylene group.

Syntheses

The following Scheme 1 provides a typical synthetic approach by which moisture-curable compositions of the present invention may be obtained.

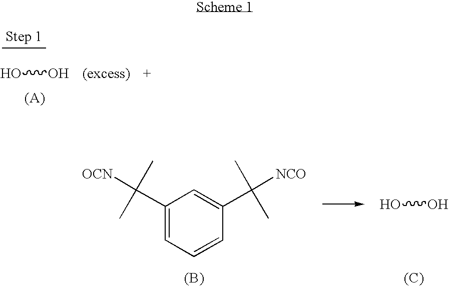

Step 1 shows the synthesis of polyol (C) having a desired length, produced by reaction of polyether polyol (A) with diisocyanate (B).

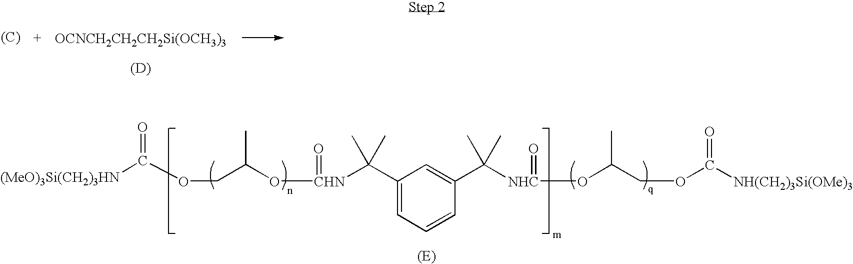

Step 2 shows the endcapping of polyol (C) with isocyanosilane (D), producing the desired polymer (E), in which n, m, and q are as defined above.

Step 3

Levels of remaining unreacted isocyanates are then determined titrimetrically, and sufficient aminoalkoxysilane is added to reduced the unreacted isocyanates to an acceptable level.

### EXAMPLES

To a nitrogen swept resin kettle is charged Polyol Acclaim 1220 (1779.1 g). The stirrer speed is set to 40 rpm and the polyol is stirred under vacuum (15 mm Hg) at 80° C. for one hour. The vacuum is broken and the reaction vessel flooded with nitrogen. To the reaction vessel is added TMXDI (21.74 g, 0.089 mol) and dibutyltin dilaurate (0.47 g). The reaction mixture is stirred, and the reaction progress is monitored by IR. When the NCO consumption is determined to have plateaued, Silquest Silane Y-5187 (74.00 g, 0.356 mol) is added to the stirring solution. A slight exotherm is seen. The reaction progress is monitored by IR. When the NCO consumption is determined to have re-plateaued, the reaction is checked for trace NCO by IR. When the trace NCO is determined to be less than 0.15% by weight, to the stirring reaction is added Tinuvin 765 (28.23 grams) and vinyltrimethoxysilane (38.40 g). The reaction mixture is stirred for 25 minutes. The batch is dropped, providing a theoretical yield of 1899.00 grams.

1. A moisture curable composition comprising the structure of formula (I): 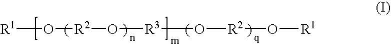
wherein
R¹ is an N-(alkoxysilylalkylene)carbamoyl group;
R² is a hydrocarbon diradical;
R³ is a diradical bis-carbamoyl;
n is 150 to 500;
m is 0.2 to 1.0; and
q is n.

2. The composition of claim 1, wherein the alkylene linkage of the N-(alkoxysilylalkylene)carbamoyl group has 1 to 4 carbon atoms.

3. The composition of claim 1, wherein the hydrocarbon diradical comprises a straight-chained or branched C₂-C₆ alkylene diradical.

4. The composition of claim 1, wherein diradical bis-carbamoyl R³ has the structure 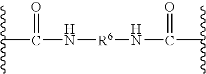
wherein R⁶ is a C₁-C₂₀ hydrocarbon diradical.

5. The composition of claim 1, wherein N-(alkoxysilylalkylene)carbamoyl group R¹ is a hydrolyzable group.

6. The composition of claim 1 comprising the structure: 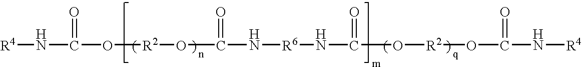
wherein
R² is a straight-chained or branched C₂-C₆ hydrocarbon diradical;
R⁴ is a moisture curable alkoxysilylalkylene radical;
R⁶ is a C₁-C₂₀ hydrocarbon diradical;
n is 150 to 500;
m is 0.2 to 1.0; and
q is n.

7. The composition of claim 6, wherein R⁴ has the formula R⁹₍₃₋ₓ₎Si(OR⁷)_{X}—R⁸—
wherein
each R⁷, individually, is straight-chained or branched C₁-C₆ alkyl;
R⁸ is straight-chained or branched C₁-C₄ alkylene;
each R⁹, individually, is a straight-chained or branched C₁-C₆ alkyl; and
X is 1 to 3.

8. A method for preparing a polymer comprising the steps of:
a) reacting a polyether polyol with a diisocyanate to produce a first reaction mixture containing a first product;
b) endcapping the first reaction product by reacting it with as alkoxysilylalkylene isocyanate to produce a second reaction mixture containing a second reaction product; and
c) adding to the second reaction mixture an amino alkylenealkoxysilane at a time when the alkoxysilylalkylene isocyanate consumption has been determined to have plateaued, so as to reduce the amount of any unreacted isocyanate groups.

9. The method of claim 8, wherein the first reaction product has a molecular weight of about 12,000 to about 24,000 atomic mass units.

10. The method of claim 8, wherein the endcapping of step b) is performed at a time when the diisocyanate consumption has been determined to have plateaued.

11. The method of claim 8, wherein the unreacted diisocyanate groups are reduced to a level of about 0.1 wt % or less.

12. The method of claim 8, wherein the polyether polyol of step a) comprises propylene oxide polyol having an average molecular weight of about 10,000 to about 14,000 atomic mass units.

13. The method of claim 8, wherein the alkoxysilylalkylene isocyanate of step b) has the formula
R⁹₍₃₋ₓ₎Si(OR⁷)_{X}—R⁸—NCO
wherein
each R⁷, individually, is straight-chained or branched C₁-C₆ alkyl;
R⁸ is a straight-chained or branched C₁-C₄ alkylene;
each R⁹, individually, is straight-chained or branched C₁-C₆ alkyl; and
X is 1 to 3.

14. (canceled)

15. A composition comprising the structure: 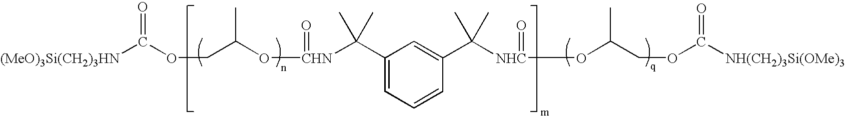
wherein
n is 207;
m is 0.74; and
q is n.

16. The composition of claim 1, further comprising a moisture cure catalyst.
